(19) United States
(12) Patent Application Publication
(10) Pub. No.: US 2026/0205156 A1
(43) Pub. Date: Jul. 16, 2026

(54) BATTERY CHARGING AND COMMUNICATIONS USING CHIRP SPREAD SPECTRUM SIGNAL MODULATION

(71) Applicant: Enatel, Christchurch (NZ)

(72) Inventors: Matthew James Blake, Christchurch (NZ); Arthur Johannes Hein de Beun, Christchurch (NZ)

(21) Appl. No.: 19/122,528

(22) PCT Filed: Nov. 1, 2023
(86) PCT No.: PCT/NZ2023/050120

§ 371 Date: Apr. 18, 2025

Related U.S. Application Data
(60) Provisional application No. 63/421,520, filed on Nov. 1, 2022.

(51) Int. Cl. H04B 1/69; H04B 3/54

(52) U.S. Cl. CPC H04B 1/69; H04B 3/54; H04B 2001/6912

(57) ABSTRACT

A battery charging apparatus configured to charge at least one battery includes a battery charger configured to generate a DC charging current, a cable coupling the battery charger to the at least one battery and configured to supply DC charging current to the at least one battery, a first transceiver coupled between the battery charger and the cable, and at least one second transceiver coupled between the cable and the at least one battery, wherein each of the first transceiver and the at least one second transceiver is configured for bidirectional communication of data over the cable using chirp spread spectrum signal modulation.

### CROSS-REFERENCE TO RELATED APPLICATION

This application claims priority to U.S. provisional application No. 63/421,520, filed Nov. 1, 2022, which is hereby incorporated by reference in its entirety.

### TECHNICAL FIELD

This disclosure relates to electronic communications over a power line, including communications between a battery charger and a battery management module.

### BACKGROUND

Electric forklifts and other electric vehicles are used throughout the global supply chain, to move goods around warehouses and onto transport vehicles and for other industrial and commercial purposes. Such large electric vehicle run on large batteries that need to be charged. It is important that vital factors of the battery are recorded such as acidity, voltage, and temperature so that faulty or dangerous batteries can be replaced before they cause damage or delays. Battery monitoring modules (BMM) are devices that are attached to large electric vehicle batteries to record these important data parameters. When a battery is plugged into a charger, the BMM which is attached to the battery uploads all of its historical data about the battery to the charger.

### BRIEF DESCRIPTION OF THE DRAWINGS

FIG. 1 is a diagrammatic view of an example battery charging system.

FIG. 2 is schematic view of an example battery system.

FIG. 3 is a block diagram view of an example chirp spread spectrum signal modulation communications system that may find use with the battery charging system of FIG. 1 and the battery system of FIG. 2.

FIG. 4 is a block diagram view of a portion of the communications system of FIG. 3, illustrating data transmission functionality of the communications system in greater detail.

FIG. 5 is a block diagram view of a portion of the communications system of FIG. 3, illustrating data receipt functionality of the communications system in greater detail.

### DETAILED DESCRIPTION

Known methods for communications between a battery management module and a charger can be unreliable. As a result, it may be difficult get accurate data from a battery, or from sensors monitoring the battery, and therefore determine the health of the battery. In a worst-case scenario this could result in a battery failing suddenly, meaning an electric vehicle could not be used until a replacement is found, resulting in delays. These delays can have flow-on effects to the entire global supply chain, and cause materials/packages to experience delays in shipping, for example.

One current method of communications between a battery management module and a charger is known as frequency shift keying. This method is susceptible to interference from narrowband noise, which is produced by switching power supply circuits of some chargers. As a result, using frequency key shifting, data recorded on the BMM's may not be transferred to the chargers reliably under some use cases.

The present disclosure improves upon known methods for communication between a BMJVI and a battery charger by implementing chirp spread spectrum signal modulation for communications signals on a power line. By using the techniques disclosed herein, more reliable communications can be provided on a power line without dedicated computing resources and without monopolizing existing computing resources in the BMM and battery charger.

Disclosed herein is a battery charging apparatus configured to charge at least one battery. The battery charging apparatus comprises a battery charger configured to generate a DC charging current; a cable coupling the battery charger to the at least one battery and configured to supply DC charging current to the at least one battery; a first transceiver (e.g., charger-associated transceiver) coupled between the battery charger and the cable; and at least one second transceiver (e.g., battery-associated transceiver) coupled between the cable and the at least one battery. Each of the first transceiver and the at least one second transceiver is configured for bidirectional communication of data over the cable using chirp spread spectrum signal modulation.

Data is modulated using wideband ‘chirps’, which spread the data over a wide spectrum. Chirps are signals with time changing frequencies (based on a mathematical relationship). This encoded data is then transmitted using custom hardware. The chirp pattern used, as well as the error prevention scheme, forms a unique modulation scheme. This is a power line carrier scheme, meaning data will be communicated over a DC power line cable. This is a noisy environment, which includes noise sources like switched-mode power supplies. The resulting power line carrier chirp spread spectrum modulation scheme according to certain embodiments minimizes the effect of this noise, as well as providing a simple and low power method of communications.

Referring back to the battery charging apparatus introduced above, in certain embodiments the apparatus further comprises at least one battery monitoring module (BMM) coupled between the cable and the at least one battery, wherein the at least one second transceiver is associated with (optionally integrated with) the BMM. In certain embodiments, a BMM comprises multiple sensors configured to monitor parameters of an associated battery. In certain embodiments, the data communicated between transceivers is indicative of at least one (or multiple) of: battery voltage, charging voltage, current flow, battery temperature, battery electrolyte level, Li-Ion battery management signals, battery charger status information, and communication acknowledgment.

In certain embodiments, each transceiver may include a processor (e.g., embodied in a microcontroller) and associated software configured to be executed by the processor. In certain embodiments, each of the first transceiver and the at least one second transceiver comprises a processor and software configured to communicate linear frequency modulated chirps, comprising chirps that increase in frequency in a linear fashion, when performing the chirp spread spectrum signal modulation.

In certain embodiments, each of the first transceiver and the at least one second transceiver comprises a processor and software configured to generate different symbols by cyclically rotating chirps when performing the chirp spread spectrum signal modulation.

In certain embodiments, each of the first transceiver and the at least one second transceiver comprises a processor and software configured to generate a passband chirp signal comprising the data, without frequency shifting of a previously generated baseband chirp signal.

In certain embodiments, the at least one battery comprises a plurality of batteries, wherein each battery may have an associated BMM and second transceiver. In certain embodiments, the at least one battery comprises a lithium-ion battery, a lead-acid battery, or any other suitable type of battery.

The power line carrier chirp spread spectrum modulation scheme allows for reliable data transmission over DC power lines in noisy environments. In certain embodiments, this allows for reliable bidirectional communication between a battery charger and one or more battery monitoring modules associated with one or more batteries being charged by the battery charger. The modulation scheme spreads the data over a wide spectrum, minimizing the effect of narrowband noise.

Before proceeding to an illustration of an example system for chirp spread spectrum modulation for communications over a power line, principles applied in the example systems will first be described.

Chirp Spread Spectrum Modulation is a generic term for spread spectrum digital communication schemes that are based off encoding data into chirp signals. A spread spectrum communication system uses a large bandwidth to improve the performance of a system in noise. In communications theory, there is a fundamental trade-off between bandwidth and the signal-to-noise ratio required to transmit error-free information. This trade-off can be derived from the Shannon-Hartley theorem, which gives the maximum data rate a noisy channel can support and is shown in equation (1) below:

$$C = BW {log}_{2} ( 1 + \frac{S}{N} ) \qquad ( Eq . 1 )$$

where C is the channel capacity in bits/second, BW is the bandwidth in Hz, S is the received signal power and N is the noise power. Assuming that S/N<<1, which is generally the case in spread spectrum communications, then equation (1) can be rearranged as shown in equation (2) below:

$$\frac{BW}{C} ∝ \frac{N}{S} \qquad ( Eq . 2 )$$

Accordingly, an increase in BW can be exchanged for reduction in signal power if the channel bit rate and noise power are held constant. This is the fundamental idea behind spread spectrum communications: a very large bandwidth is used such that reliable communication is possible at very low SNR.

CSS applies this spread spectrum theorem to communication using chirp waves. A chirp wave is a sinusoid in which the frequency continuously varies with time. One type of chirp wave is a linear chirp wave. A linear chirp wave's frequency either increases or decreases linearly in time. A chirp that increases in frequency over time is known as an up chirp, and a chirp that decreases in frequency over time is known as a down chirp.

Systems that include linear frequency modulated chirp waves are based on modulating linear chirp waves by changing the starting frequency of an up chirp. The chirp signal that starts at the minimum frequency,

$$- \frac{BW}{2}$$

and sweeps up to

$$- \frac{BW}{2}$$

is denoted as xo(t), or a “base chirp” which is given by equation (3) below:

$${x}_{0} ( t ) = {e}^{j ( 2 π {f}_{c} t + 2 π \frac{β}{2} {t}^{2} )} \qquad ( Eq . 3 )$$

where β is the frequency rate of change. β is related to the symbol time Ts and the bandwidth of the chirp BW as shown in equation 4 below:

$$β = \frac{BW}{{T}_{s}} \qquad ( Eq . 4 )$$

The modulation order, M, which is equal to the number of bits that can be encoded per symbol, is related to the symbol time as shown in equation (5) below:

$${T}_{s} = \frac{{2}^{M}}{BW} \qquad ( Eq . 5 )$$

The modulated chirp symbols, xₘ(t), are then given by equation (6) below:

$${x}_{m} ( t ) = {x}_{0} ( ( t - \frac{{mt}_{s}}{M} ) mod ( {T}_{s} ) ) , t ∈ [ 0 , {T}_{s} ] \qquad ( Eq . 6 )$$

where m controls the starting frequency of the chirp symbol and the modulus by Tₛ has the effect of limiting the spectrum of the chirp symbols to the same spectrum of the base chirp xo(t). The modulus causes the chirp symbols to wrap around to −BW/2 once they reach the maximum frequency BW/2. Due to the time-frequency equivalency of linear chirp signals, these symbols can also be generating by cyclically rotating a base up chirp in time.

Because of the relationship between Tₛ, BW and M, a symbol at baseband is always made up of 2^{M} samples when sampled at the Nyquist rate. Therefore, by cyclically shifting the basic up chirp sample by sample, 2^{M} different symbols can be generated.

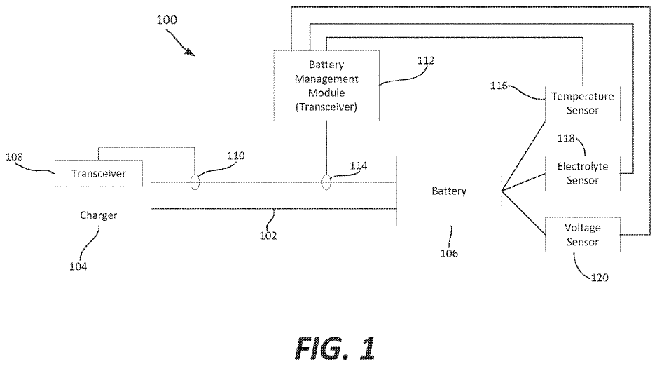

FIG. 1 is a schematic diagram of a battery charging apparatus 100 including a DC charging power cable 102 (which may include multiple conductors) coupled between a battery charger 104 and a battery 106. A first transceiver 108 associated with (and optionally integrated into) the battery charger 104 is coupled with the charging cable 102 via a first coupling toroid 110. A second transceiver in the form of, or integrated into or coupled with, a battery management module (BMM) 112 associated with the battery 106 is coupled with the charging cable 102 via a second coupling toroid 114. The toroids 110, 114 enable the first and second transceivers 108, 112 to output signals to, and read signals from, the power cable 102. Each toroid 110, 114 may be, for example, a PLC toroid. One or more (e.g., a plurality of) sensors may be coupled to the battery for detecting and outputting aspects of the operational state of the battery. Additionally or alternatively, one or more sensors may be coupled to the power cable 102 and/or the battery charger 104. The sensors may be configured to measure one or more of battery voltage, charging voltage, current flow, battery temperature, battery electrolyte level, Li-Ion battery management signals, battery charger status information, or communication acknowledgments. For example, the sensors may include a temperature sensor 116, an electrolyte sensor 118, a voltage sensor 120, and/or one or more other sensors. The sensors 116, 118, 120 may be in electronic communication with the BMM when coupled with the battery 106.

In operation, the BMM may record measurement data from the sensors 116, 118, 120 as the battery 106 is used and discharged. When the battery 106 is connected to the charger 104 to charge, the BMM transceiver 112 may transmit that measurement data, or conclusions based on that data, to the charger 104 over the power line 102 according to the techniques of this disclosure. The charger 104 may be stationary or may be mobile, in embodiments, for connecting to the battery 106.

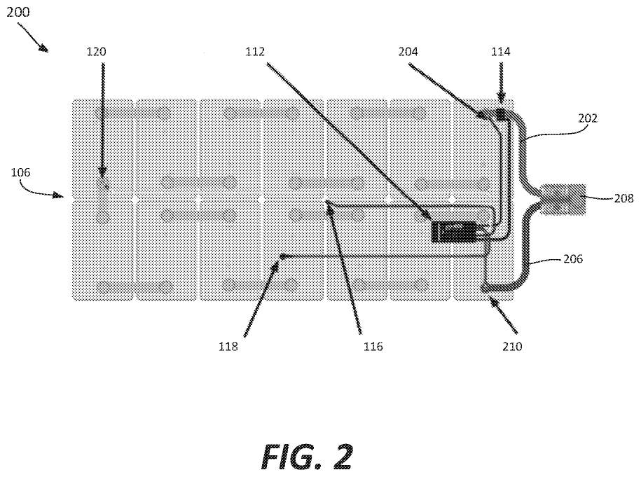

FIG. 2 is a schematic diagram showing a battery system 200 including a battery 106 (containing fourteen cells arranged in series) and the battery monitoring module 112 (which may include an integrated second transceiver) mounted on the battery 106. The system 200 also includes the temperature sensor 116, the electrolyte sensor 118, and the voltage sensor 120 also mounted on the battery 106 so as to perform their particular measurements. As shown in FIG. 2, each of the sensors 116, 118, 120 may be coupled to and in communication with the BMM including transceiver 112 via a respective communications wire. The second communications toroid 114 may be coupled to a particular one of the wires or cables of the power cable, such as the negative DC supply cable 202. The toroid 114 may be coupled to the cable 202 proximate the negative DC supply terminal 204 of the battery 106, in some embodiments. The battery 106 may be further coupled to the DC supply line 102 at a positive DC terminal 210. The positive DC supply line 206 and negative DC supply line 202 may, when coupled to a charger via connector 208, form a part of the charging cable 102.

Although the sensors 116, 118, 120 are shown coupled to the battery 106, one or more sensors may additionally or alternatively be coupled to the power line 102, the battery charger 104 (shown in FIG. 1), and/or another component of a battery system or battery charging system or apparatus.

The battery system 200 may find use in a wide variety of implementations. For example, the battery system 200 may be used in an electric forklift or other electric industrial or commercial vehicle, or any other electric vehicle or electric device with a rechargeable battery.

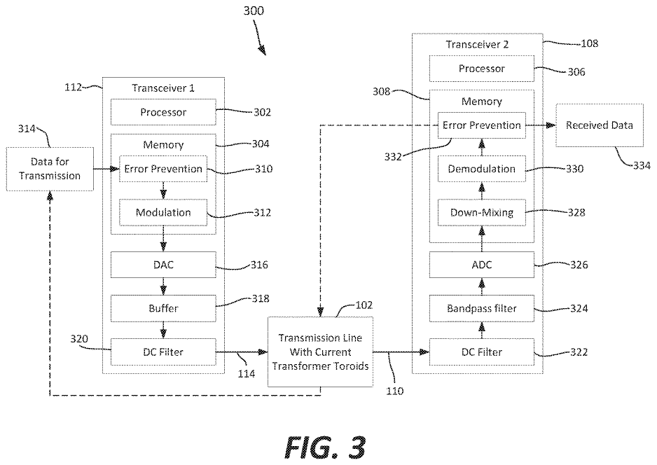

FIG. 3 is a block diagram showing communication operations in a battery charging apparatus 300 utilizing chirp spread spectrum signal modulation over a DC charging cable. The apparatus 300 includes the transceivers 108, 112, coupled to each other by a transmission line 102 via current transformer toroids. As will be described below, the transceiver 112 (which, as noted above, may be associated with a BMM) may transmit to the transceiver 108 (which may be associated with a battery charger) by chirp spread spectrum signal modulation over the power line 102.

The transceiver 112 includes a processor 302 and a non-transitory, computer-readable memory 304 including instructions that, when executed by the processor 302, cause the transceiver 112 to perform one or more operations, functions, etc. discussed herein. The instructions on the memory 304 may be in the form of software executable by the processor 302.

Similarly, the transceiver 108 includes a processor 306 and a non-transitory, computer-readable memory 308 including instructions that, when executed by the processor 306, cause the transceiver 108 to perform one or more operations, functions, etc. discussed herein. The instructions on the memory 308 may be in the form of software executable by the processor 306.

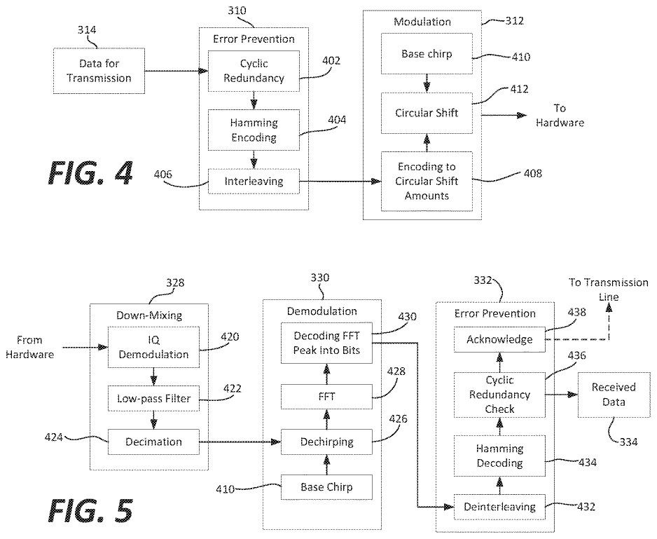

The memory 304 may include one or more functional modules for performing certain functionality. For example, the memory 304 may include an error prevention module 310 that receives certain data for transmission 314, performs error prevention functions described below, and outputs to a modulation module 312, which performs functionality described below and outputs to hardware of the transceiver 112, which may include a digital-to-analog converter (DAC) 316, a buffer 318, and a DC filter 320. Functionality of the transceiver 112 will be described below with respect to FIG. 4.

The transceiver 108 also includes hardware such as a DC filter 322, a bandpass filter 324, and an analog-to-digital converter (ADC) 326. The hardware inputs modules of the memory 308, which modules may include a down-mixing module 328, which inputs to a demodulation module 330, which outputs to an error prevention module 332, which outputs the received data 334. Functionality of the transceiver 108 will be described below with respect to FIG. 5.

FIG. 4 is a block diagram of a portion of the transceiver 112. Referring to FIGS. 3 and 4, the message data, which may include data from one or more sensors, is input into the error prevention module 310.

The error detection and coding system used in the apparatus 300 may be based upon the theory of cyclic codes. Cyclic codes are a subclass of linear block codes. Linear block codes map each k-tuple input message into each n-tuple output message with n>k so that the redundancy bits which the receiver uses for the error detection and correction are introduced into the information sequence. Cyclic codes provide significant benefits. First, coding can be easily implemented by using fast speed shift registers with feedback connections. Second, because cyclic codes have a nice algebra structure, it is possible to construct higher order correction codes.

A Cyclic redundancy check (CRC) is a type of shortened cyclic codes. It is not cyclic code, but it is derived from the cyclic code. A shortened cyclic code has at least the same error detection and correction capability as the cyclic code. One shift register circuit can be used to as the encoder and the decoder.

Referring to FIG. 4, the error prevention module 310 includes a cyclic redundancy submodule 402, which receives the data for transmission 314 and in which a 16-bit cyclic redundancy check (CRC) code is used to encode the data. This allows the data to be checked at the receiver to make sure the transmission occurred as intended. This polynomial used to for this encoding is g (X)=1+X\hat{ }5±X\hat{ }12±X\hat{ }16.

The error prevention module 310 further includes a hamming encoding submodule 404 that receives the output of the cyclic redundancy encoded data and which includes a (7, 4) hamming encoder (meaning every 4-bits of code are assigned 3 parity bits). This is done to provide forward error correction, which allows the receiver to be able to correct errors in the received message. The polynomial used for the Hamming encoding is g (X)=1±X+X\hat{ }3. The Hamming encoding maps a k-tuple data word into an n-tuple codeword. Because n>k, the remaining n-k digitals are parity check digits which are used by the decoder to correct and detect errors. The Hamming encoding may include a code length n of n=2^{m}−1, a number of information symbols k of k=2^{m}−m−1, a number of parity-check symbols m of m=n−k, and an error-correcting capability of t−1.

The encoder may be used by, first, setting the shift register to zero. The message polynomial u(x) may then be multiplied by Xₙ₋ₖ. The message u(x) may be shifted into the circuit from the right end. The message u(x) moved into the circuit may be generated by dividing X_{n-k*u(x)} by the generator polynomial g(x). After the complete message u(x) enters the circuit, the digitals in the register form the remainder polynomial b(X). b(X)+Xₙ₋ₖu(x) constructs a codeword.

The error prevention module 310 further includes an interleaving submodule 406 which may receive the encoded data from the hamming encoding submodule 404 and may reduce the transmissions susceptibility to burst errors (i.e. when the distortion is concentrated at short bursts in time). The interleaver 406 does this by mixing up bits from separate code words, so that bits from the same code word are temporally separated. That is, the interleaver 406 may shuffle binary bits from several codewords so that the binary bits from any codeword are well separated during transmission. When a deinterleaver (described below with respect to FIG. 5) reassembles the codewords, the error busts are broken up and distributed across several codewords. The isolated errors are then corrected by a hamming decoder at the receiver, again as described below with respect to FIG. 5.

The interleaver 406 inputs the encoded, interleaved data (referred to herein as xₘ[n]) to the modulation module 312, and more specifically to a circular shift amount encoder submodule 408 in which each symbol is encoded into a circular shift amount. A base chirp submodule 410 generates or outputs a base chirp signal xo[n] in which the frequency is increased linearly from 75 kHz to 135 kHz or other appropriate frequency range for a particular application. In some embodiments, the base chirp signal may be stored and output in digital form, rather than generated, by base chirp submodule 410. A circular shift submodule 412 applies the circular shift amounts from the circular shift amount encoder 408 to the base chirp signal from the base chirp submodule 410. As a result, all M symbols, xₘ[n] are represented with cyclically shifted versions of xₒ[n].

Referring again to FIG. 3, the modulated chirp sequence is then transmitted using the several hardware stages, in some embodiments. First, the modulated chirp sequence signal is converted by a digital-to-analog converter (DAC) 316 to an analogue voltage signal. The DAC 316 may be a component of a microcontroller of the transceiver 112 (e.g., of the BMM) and may be buffered. The analog signal's amplitude may then be made rail-rail, by passing it through a transistor buffer stage 318 that has been linearized using the feedback loops of operational amplifiers (op-amps).

DC offsets are removed from the signal by a DC filter 320 that may include a capacitor chain. This capacitor chain may include resistance to dampen any resonance between the transmission line's inductance and this capacitor bank.

The chirp signal is output to the power line 102 through a toroid. This output channel may include several stages such as, for example: copper traces on the BMM; PLC wires connecting the BMM to the PLC toroid; a PLC toroid/current transformer that magnetically couples the BMM PLC signal to the DC power cable 102; the DC power cable 102; a PLC toroid/current transformer that magnetically couples the transceiver 108 to the DC power cable 102; PLC wires connecting the transceiver 108 to its PLC toroid; and copper traces on the transceiver 108.

In transceiver 108, the analog signal is received and initially input to various hardware stages. DC offsets are removed from the signal by a DC filter 322 that may include a capacitor chain. This capacitor chain may include resistance to dampen any resonance between the transmission line's inductance and this capacitor bank.

A flat-passband band-pass filter 324 may receive the signal from the DC filter 322 and may remove noise outside of the signal's bandwidth. For example the bandpass filter 324 may eliminate signals outside of the range of 75 kHz to 135 kHz. The bandpass filter 324 may use two op-amps in series to remove passband ripple and therefore increase signal quality. The bandpass filter may input the signal to an analogue to digital converter (ADC) 326 to convert the signal to digital form.

Referring to FIGS. 3 and 5, the received chirp sequence, after hardware stages of the transceiver 108, may be processed by the modules 328, 330, 332 to determine the received data 334.

The down-mixing module 328 may down-mix the signal to a suitable bandwidth for further signal processing. The down-mixing module 328 may include an IQ demodulation submodule 420 that converts the received real-valued passband signal into a baseband signal. The IQ demodulation submodule 420 may separate the complex and real components of the received signal by multiplying the received signal by two sinusoids that are 90° out of phase with each other. The resulting IQ signal may be a complex signal with a real part and an imaginary part. The down-mixing may split the frequency spectrum into two spectrums with separate centers.

A low-pass finite impulse response (FIR) filter submodule 422 is then applied to the baseband signal to remove any information about the baseband signal's bandwidth. As noted above, the down-mixing may split the frequency spectrum into two spectrums with separate centers; the low-pass filter may remove the lower of those two spectrum portions.

The down-mixing module 328 may further include a decimation submodule 424 that is applied to the output of the lowpass filter 422 to improve the computational efficiency of the subsequent digital signal processing steps, by removing samples that are now unnecessary due to the signal bandwidth being reduce by IQ demodulation and low-pass filtering. Decimation reduces the sampling rate by discarding every nth sample of a signal, where n depends on how much the signal was oversampled by. Decimation improves the efficiency of any following digital signal processing because there are less samples to manipulate.

The down-mixed signal is then demodulated by the demodulation module 330. The demodulation module 330 includes a de-chirping submodule 426 that multiplies the down-mixed signal by the complex conjugate of the base chirp 410. This removes the time-varying frequencies caused by CSS modulation and leaves a signal of constant frequencies, which relate to the encoded circular shift amount generated at submodule 408.

A fast Fourier transformer (FFT) submodule 428 receives the de-chirped signal and applies an FFT algorithm to calculate the magnitude of each of the constant frequencies making up the de-chirped signal.

The highest amplitude FFT bin is then translated into an estimate of the transmitted symbol by a decoding submodule 430.

The demodulated signal is then decoded into a message by the error prevention module 332, which includes a deinterleaving submodule 432 that deinterleaves the demodulated signal by reversing the temporal shifting that was performed by the interleaver 406. The deinterleaver 432 may store the interleaving scheme or pattern applied by the interleaver 406 and may reverse that scheme or pattern.

The error prevention module 332 may further include a Hamming decoder submodule 434, which may check the signal for errors by calculating the message's syndrome. The Hamming decoder submodule 434 may calculate the position of errors, if any are present, so that they can then be then attempted to be corrected by the decoder. The Hamming decoder submodule 434 may, in some embodiments, shift the received vector r (X) into the circuit from the left end until as the whole received vector r (X) is shifted into the circuit, at which time the digits in the register form the syndrome. The error pattern corresponding to the syndrome can be determined based on a lookup table, such as the example lookup table below.

| Error Pattern | Error Polynomial | Syndrome Vector |
|---|---|---|
| (0000000) | 0 | (000) |
| (1000000) | 1 | (100) |
| (0100000) | X | (010) |
| (0010000) | X² | (001) |
| (0001000) | X³ | (110) |
| (0000100) | X⁴ | (011) |
| (0000010) | X⁵ | (111) |
| (0000001) | X⁶ | (101) |

The error prevention module 332 may further include a cyclic redundancy check submodule 436 that may decode the data and determine if any errors are present. The cyclic redundancy check submodule 436 may function, for example, by setting all shift registers to zero, inputting the information sequence into the shift register circuit. If, after the entire information sequence is input, any non-information registers have a nonzero value, an error is present.

At submodule 438, an acknowledgement may optionally be made to the transmitter if the message was received correctly, or a request for retransmission is made if uncorrectable errors are detected. The acknowledgment or request may be transmitted along the power line 102 according to the same methodology used to transmit the data for transmission 314. That is, both the transceiver 112 and the transceiver 108 may include both transmit and receive functionality as detailed in FIGS. 3, 4, and 5.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A battery charging apparatus configured to charge at least one battery, the battery charging apparatus comprising:
a battery charger configured to generate a DC charging current;
a cable coupling the battery charger to the at least one battery and configured to supply DC charging current to the at least one battery;
a first transceiver coupled between the battery charger and the cable; and
at least one second transceiver coupled between the cable and the at least one battery;
wherein each of the first transceiver and the at least one second transceiver is configured for bidirectional communication of data over the cable using chirp spread spectrum signal modulation.

2. The battery charging apparatus of claim 1, further comprising at least one battery monitoring module (BMM) coupled between the cable and the at least one battery, wherein the at least one second transceiver is associated with the at least one battery monitoring module.

3. The battery charging apparatus of claim 1, wherein the data is indicative of at least one of:
battery voltage, charging voltage, current flow, battery temperature, battery electrolyte level, Li-Ion battery management signals, battery charger status information, or communication acknowledgment.

4. The battery charging apparatus of claim 1, wherein each of the first transceiver and the at least one second transceiver comprises a processor and software configured to communicate linear frequency modulated chirps, comprising chirps that increase in frequency linearly, when performing the chirp spread spectrum signal modulation.

5. The battery charging apparatus of claim 1, wherein each of the first transceiver and the at least one second transceiver comprises a processor and software configured to generate different symbols by cyclically rotating chirps when performing the chirp spread spectrum signal modulation.

6. The battery charging apparatus of claim 1, wherein each of the first transceiver and the at least one second transceiver comprises a processor and software configured to generate a passband chirp signal comprising the data, without frequency shifting of a previously generated baseband chirp signal.

7. The battery charging apparatus of claim 1, wherein the at least one battery comprises a plurality of batteries.

8. The battery charging apparatus of claim 1, wherein the at least one battery comprises a lithium-ion battery.

9. The battery charging apparatus of claim 1, wherein the at least one battery comprises a lead-acid battery.

10. The battery charging apparatus of claim 1, further comprising a first toroid communicatively coupling the first transceiver to the cable and a second toroid communicatively coupling the at least one second transceiver to the cable.

11. A battery charging apparatus configured to charge at least one battery, the battery charging apparatus comprising:
a battery charger configured to generate a DC charging current;
a cable coupling the battery charger to the at least one battery and configured to supply DC charging current to the at least one battery;
a first transceiver coupled between the battery charger and the cable; and
a battery management module coupled to the at least one battery, the battery management module comprising a second transceiver coupled between the cable and the at least one battery, and the battery management module configured to receive data from one or more sensors;
wherein the second transceiver is configured to transmit data from the one or more sensors to the first transceiver over the cable using chirp spread spectrum signal modulation.

12. The apparatus of claim 11, further comprising the one or more sensors, wherein the one or more sensors comprise one or more of:
a temperature sensor;
an electrolyte sensor; or
a voltage sensor.

13. The apparatus of claim 11, wherein the data is indicative of at least one of:
battery voltage, charging voltage, current flow, battery temperature, battery electrolyte level, Li-Ion battery management signals, battery charger status information, or communication acknowledgment.

14. The apparatus of claim 11, wherein each of the first transceiver and the second transceiver comprises a processor and a non-transitory, computer-readable memory storing instructions that, when executed by the processor, cause the transceiver to:
communicate linear frequency modulated chirps, comprising chirps that increase in frequency linearly, when performing the chirp spread spectrum signal modulation.

15. The apparatus of claim 11, wherein each of the first transceiver and second transceiver comprises a processor and a non-transitory, computer-readable memory storing instructions that, when executed by the processor, cause the transceiver to:
generate different symbols by cyclically rotating chirps when performing the chirp spread spectrum signal modulation.

16. The apparatus of claim 11, wherein each of the first transceiver and the second transceiver comprises a processor and a non-transitory, computer-readable memory storing instructions that, when executed by the processor, cause the transceiver to:
generate a passband chirp signal comprising the data, without frequency shifting of a previously generated baseband chirp signal.

17. The apparatus of claim 11, wherein the at least one battery comprises a plurality of batteries.

18. The apparatus of claim 11, wherein the at least one battery comprises a lithium-ion battery.

19. The apparatus of claim 11, wherein the at least one battery comprises a lead-acid battery.

20. The apparatus of claim 11, further comprising a first toroid communicatively coupling the first transceiver to the cable and a second toroid communicatively coupling the second transceiver to the cable.
